(19) United States
(12) Patent Application Publication
(10) Pub. No.: US 2026/0066969 A1
(43) Pub. Date: Mar. 5, 2026

(54) CHANNEL STATE INFORMATION PREDICTION IN A WIRELESS NETWORK

(71) Applicant: Samsung Electronics Co., Ltd., Suwon-si, Gyeonggi-do (KR)

(72) Inventors: Diwakar SHARMA, Bangalore (IN); Karthik MURALIDHAR, Bangalore (IN); Dattaraj Dileep Raut MULGAONKAR, Bangalore (IN); Santanu MONDAL, Bangalore (IN)

(21) Appl. No.: 19/103,722

(22) PCT Filed: Aug. 22, 2023
(86) PCT No.: PCT/KR2023/012422

§ 371 Date: Feb. 13, 2025

(30) Foreign Application Priority Data
Aug. 22, 2022 (IN) 202241047636
Aug. 7, 2023 (IN) 2022 41047636

(51) Int. Cl. H04B 7/06

(52) U.S. Cl. CPC H04B 7/0626; H04B 7/0639

(57) ABSTRACT

The disclosure relates to a 5G or 6G communication system for supporting a higher data transmission rate. Embodiments herein provide method performed by a user equipment (UE) in a wireless network. The method includes measuring a channel in an observation window (OW); determining a spectral estimation of the channel in the OW; determining a plurality of channel parameters based on the spectral estimation of the channel in the OW; and transmitting, to a network apparatus, a UE capability information and the plurality of channel parameters, wherein the UE capability information includes candidate value of a N4 parameter indicating a length of discrete fourier transform (DFT) vector.

### TECHNICAL FIELD

The present invention relates to a wireless communications and systems, and more specifically related to a method of channel state information prediction in a wireless network.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In conventional methods and systems, there is a feature where a User Equipment (UE) feeds back a gNB about its capabilities for any agreed features and a Base Station (BS) will take this into an account while scheduling this UE.

In traditional methods and systems, a crucial feature is the capability of User Equipment (UE) to provide feedback to the gNB (gNodeB) regarding its supported functionalities or agreed-upon features. This feedback is essential for the Base Station (BS) to consider and incorporate while scheduling communication resources for the respective UE. By exchanging information between the UE and the gNB, the network gains valuable insights into the UE's capabilities, enabling it to make informed decisions regarding resource allocation, CSI resource configuration and communication protocols. This bidirectional communication fosters efficient and optimized utilization of network resources, feedback capability resulting in enhanced performance and user experience. The feedback plays an important role in enabling seamless communication between UEs and the network infrastructure. By considering the UE's capabilities, the gNB adapts its scheduling strategies, precoder, modulation schemes, and transmit power levels to suit the specific requirements of each UE, optimizing overall system performance. Hence there is a need to develop a novel method channel state information prediction in a wireless network.

### DISCLOSURE OF INVENTION

### Technical Problem

The principal object of the embodiments herein is to provide a method of channel state information prediction in a wireless network.

Another objective of the embodiments herein is to predict or reconstruct a channel in a prediction window based on channel parameters received from a UE.

Yet another object of the embodiments herein is to determine the channel parameters based on a spectral estimation of the channel in an observation window based on a delay-doppler domain and a spectrum estimation technique.

Yet another object of the embodiments herein is to determine precoders in a prediction window based on a compressed precoding matrix index received from the UE.

Yet another object of the embodiments herein is to determine a UE capability information and the channel parameters based on an AR prediction, a linear prediction, a linear minimum mean square error (LMMSE), and a spectral based prediction performed by the UE.

Yet another object of the embodiments herein is to predict the channel for the prediction window based on the compressed precoding matrix index corresponding to the observation window received from the UE.

Yet another object of the embodiments herein is to determine the channel in multiple parts of the prediction window based on entire observation window.

Yet another object of the embodiments herein is to configure a sliding window length based on a CSI received from the UE, and a predicted CSI at the network apparatus using the CSI received from the UE.

### Solution to Problem

In one aspect, the objects are achieved by providing a method for a user equipment (UE) capability feedback-based channel state information (CSI) prediction in a wireless network. The method includes, measuring a channel in an observation window (OW); determining a spectral estimation of the channel in the OW; determining a plurality of channel parameters based on the spectral estimation of the channel in the OW; and transmitting, to a network apparatus, a UE capability information and the plurality of channel parameters, wherein the UE capability information includes candidate value of a N4 parameter indicating a length of discrete fourier transform (DFT) vector.

In another aspect the objects are achieved by providing a method performed by a network apparatus in a wireless network. The method includes, receiving, from a User Equipment (UE), a UE capability information and the plurality of channel parameters; and determining a length of an observation window (OW) and a length of a prediction window (PW) based on the UE capability information and the plurality of channel parameters, wherein the UE capability information includes candidate value of a N4 parameter indicating a length of discrete fourier transform (DFT) vector.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments, and the embodiments herein include all such modifications.

### Advantageous Effects of Invention

Embodiments of the present disclosure provides methods and apparatus for determining a length of an observation window, a length of a prediction window, and a length of a reporting window base on UE capability information.

### BRIEF DESCRIPTION OF DRAWINGS

The embodiments disclosed herein are illustrated in the accompanying drawings, throughout which like reference letters indicate corresponding parts in the various figures. The embodiments herein will be better understood from the following description with reference to the drawings, in which:

FIG. 1 illustrates a channel of an observation window and a prediction window, according to the prior arts;

FIG. 2 illustrates a scenario in which a linear combination coefficients, spatial domain, and frequency domain compression matrix of channel are determined, according to the prior arts;

FIG. 3 illustrates a scenario in which the UE feeding back LCP to the network apparatus, according to the prior arts;

FIG. 4A illustrates a scenario of determining a channel by a time domain interpolation, according to the prior arts;

FIG. 4B illustrates a scenario of determining a 2D channel by a time domain interpolation, according to the prior arts;

FIG. 5 illustrates a scenario of predicting a signal using the quantized low pass FFT bins, according to the prior arts;

FIG. 6 illustrates a system of channel prediction in a wireless network, according to the embodiments as disclosed herein;

FIG. 7A illustrates a scenario of a channel prediction at the UE side, according to the embodiments as disclosed herein;

FIG. 7B illustrates a scenario of a channel prediction at the node-B side, according to the embodiments as disclosed herein;

FIG. 8 illustrates a scenario of determining a channel in multiple parts of the PW based on the entire OW, according to the embodiments as disclosed herein;

FIG. 9 illustrates a scenario of configuring a sliding window length based on the CSI received from the UE, according to the embodiments as disclosed herein;

FIG. 10 illustrates a scenario of a channel prediction for large stationary time, according to the embodiments as disclosed herein;

FIG. 11 is a flow chart illustrating a method for channel prediction in the wireless network, according to the embodiment as disclosed herein;

FIG. 12 is a flow chart illustrating a method for the channel prediction at the UE, according to the embodiment as disclosed herein;

FIG. 13 is a flow chart illustrating a method for the channel prediction based on UE capability, according to the embodiment as disclosed herein;

FIG. 14 is a flow chart illustrating a method for the channel prediction based on UE capability, according to the embodiment as disclosed herein;

FIG. 15 is a flow chart illustrating a method for the channel prediction in the PW, according to the embodiment as disclosed herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Accordingly, the embodiments disclose a method for channel prediction in a wireless network includes monitoring a channel in an observation window (OW). The method includes determining a spectral estimation of the channel in the OW. The method includes determining a plurality of channel parameters based on the spectral estimation of the channel in the OW. The spectral estimation of the channel determined in the OW using a slepain technique The channel parameters include a number of transmit antennas at the network apparatus, a number of receive antennas at the network apparatus, subbands used by the UE, a number of delays in the channel, and doppler values. The channel parameters are determined based on the spectral estimation of the channel in the OW using one of a delay-doppler domain and a spectrum estimation technique. The method includes sending the plurality of channel parameters to a network apparatus in the wireless network for prediction or reconstruction of a channel in a predication window (PW).

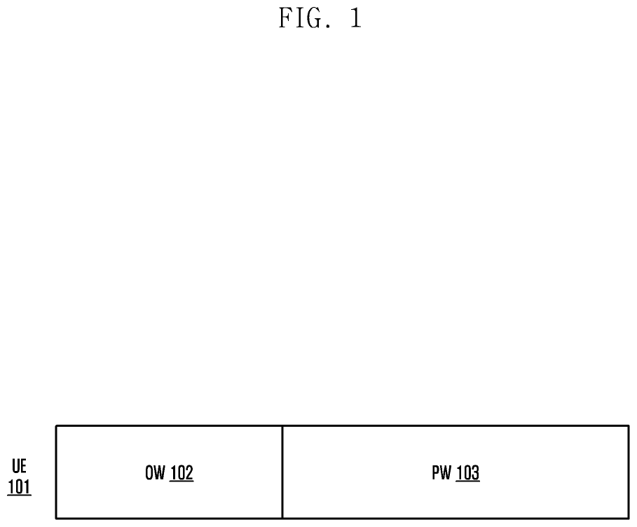

FIG. 1 illustrates a scenario of channel prediction at observation window and prediction window, according to the prior arts; Referring to the FIG. 1 considering the conventional methods and systems, a UE (101) may observe channel (H) in the observation window (OW) (102). The UE (101) may predict channel (H) in the prediction window (PW) (103). The length of the prediction window (103) and the observation window (102) may be order of coherence time. A Linear prediction, an AR prediction, and a wiener prediction may be leveraged for the prediction purpose.

Unlike to the conventional methods and systems, prediction window (103) may change dynamically based on the channel measurements. The prediction window (103) may change dynamically based on the UE capability.

In an embodiment, a spectrum estimation method for channel prediction, precoding matrix index (ω₁, ω₂, ω₃) may be accurately estimated. Convention FFT basis is spectrally inefficient and result in leakage of energy while spectrally efficient basis like slepian may be used for spectral estimation of ω₁, ω₂, ω₃. Moreover, ω₁, ω₂, ω₃ may be used in the prediction/reconstruction of channel in prediction window (PW).

Channel could be Represent as an Example

$$Y = {a}_{n} {e}^{- i ω1 n} + {b}_{n} {e}^{- i ω 2 n} + {c}_{n} {e}^{- i ω3 n} \qquad ( i )$$

Unlike to the conventional methods and systems, the channel prediction may be enhanced with the spectrally efficient basis like slepian. The prediction window (103) may change dynamically based on the stationary time and number of ω₁, ω₂, ω₃. The prediction window (103) may change dynamically based on the UE estimation capability of ω₁, ω₂, ω₃.

For example, if channel is NRx×NTx×Nsubbands where NRx, NTx and Nsubbands are number of receive, transmit antennas and subbands. Predicting a 3D channel is difficult as it has many Doppler components. For spectral based estimation, there is a need to observe window size to resolve closely based Doppler frequencies. Hence the complexity is high.

The UE (101) may be configured to predict in delay-Doppler domain. In delay-Doppler domain, the number of Doppler components is very less. Hence, the Doppler component may be estimated easily in the observation window (102). In an embodiment, multi-taper Thompson spectral estimation (pmtm in matlab) that uses Slepian sequences internally as Slepain has least leakage and may perform in delay-Doppler domain of one antenna. Doing across all antenna is very complex. Extension to other antennas is just by using steering vector as often times only one dominant Doppler component is available. Slepian based spectral estimation is more complex. There is a need to estimate the Doppler components by phase changes over adjacent samples if there are one (or very less) Doppler components.

The proposed method may ensure spectral estimation in angle-delay-Doppler domain. All spectral estimation estimates the Doppler components in the observation window (102) and uses the estimated Doppler components to predict/reconstruct in the predication window (103). The disadvantage is huge complexity on the UE side though such spectral estimation techniques on channel is very accurate. The UE (101) may predict using w2 in the observation window (102) based on spectral estimation as well. The Doppler components in w2 are also very less and number of w2 elements is one to four, so the complexity is less but w2 has a phase ambiguity problem and prediction is now not well behaved. The advance algorithms are used to calculate the phase ambiguity problem due to Eigen vector computations. Therefore, the angle-delay-Doppler domain is used to resolve the phase ambiguity. But all this takes more complexity. Either way it is very complex for the UE (101) and the UE (101) may be not capable of doing this.

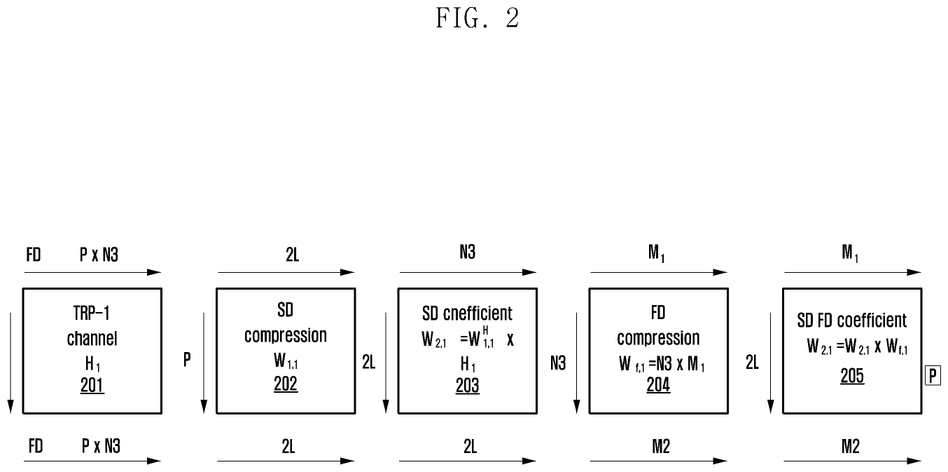

FIG. 2 illustrates a scenario in which a linear combination coefficients, spatial domain, and frequency domain compression matrix of a channel are determined, according to the prior arts;

At step 201, measuring a channel matrix H₁=P×N3.

At step 202, measuring SD matrix W_{1,1}=P×2L, where P is N1×N2 per polarization.

At step 203, measuring SD coefficients

$${W}_{2 , 1} = {W}_{1 , 1}^{H} \times {H}_{1}$$

FD compression W_{f,1}=N3×M.

At step 204, measuring SD-FD coefficients [symbol] =W_{2,1}×W_{f,1} [symbol] =2L×M matrix

At step 205, determining precoder:

$${W}_{1 , 1} {W}_{f , 1}^{H} .$$

W₁, W₂, \tilde{W}₂, Wⱼ for a particular subband may be extended across multiple time instants (third dimension) in presence of Doppler as follows: W₁ be 2N_{T}×2L (2 no. of Tx antennas per pol.×2 no. of beams);

W₂ be 2L×N₃×N (2 no. of beams×no. of subbands×no. of time instants);

\tilde{W}₂ be 2L×M×N (2 no. of beams×no. of FD compressed elements×no. of time instants); Wⱼ is N₃×M matrix.

In an embodiment, the channel feedback in Doppler domain includes a linear prediction. In linear prediction, the channels in time and frequency are governed by prediction coefficients. In the simplest case, a future channel value in time domain is a linear combination (using linear prediction coefficients) of past channel values. The error in prediction is much lesser than the error between a current and previous value. So, to feedback values of lesser magnitude may result in lesser overhead. Hence, there is a need to feedback the linear predictor coefficients.

In Doppler Components, a frequency-selective channel varies slowly and may be quite accurately represented by a few FFT bins (if FFT is taken of the channel across frequency), The same holds for a channel variation across time.

For example, in N values across time of the channel and considering N-point FFT, the channel may be quite accurately reconstructed using a few (a) FFT bins (lesser than N). These a FFT bins may be learnt using a subset N₁<N and N₁>a sample. Once the a FFT bins are learnt, the remaining N−N₁ samples may be reconstructed based on these FFT bins. If done on multipath in time domain, it is called as delay-Doppler model.

For example, Kalman filter ensures a MMSE estimate of a noisy signal, if the variation of the signal is captured in a state equation. The Kalman filter may have a linear channel predictor coefficient (LCP) as part of the state equation.

The LCP may predict a future channel value but the Kalman filter may correct the predicted value thereby minimising the error. The Kalman filter works with Noisy observations. The feedback is quantized, so the channel reconstructed at the network apparatus is a noisy version of the true channel. The Kalman filter may give better estimate of the downlink channel. There is a need to feedback the error variance of linear prediction, LCP and error variance due to the quantization. Further, the network apparatus need not work with quantized channel values, instead the network apparatus may work with more accurate values. Mainly to reduce quantization noise (if that has an impact).

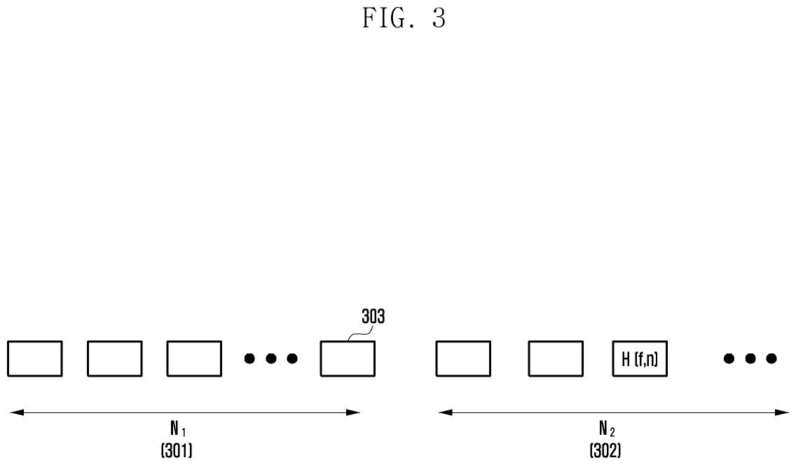

FIG. 3 illustrates a scenario in which the UE feeding back the LCP to the network apparatus, according to the prior arts;

Referring to FIG. 3 depicts N1 sample region 301, and N2 sample region 302, CSI-RS 303. The UE (101) calculates LCP/error variance of LCP, quantization error variance/Doppler coefficients. The CSI-RS may be sent over both N1 sample region 301 and N2 sample region.

$$N = N 1 + N 2 \qquad ( ii )$$

The UE (101) feeds back linear channel prediction/error variance of linear channel prediction, quantization error variance/Doppler coefficients/to the network apparatus. This time instant is called as feedback point or FP.

Linear channel prediction: Let H(f, n; a) be the channel at frequency location f and time instant n. The sampling instants may be anything in time and frequency. For example, f may be once every RB/subband and n may be once every slot/10 slots. It corresponds to ath Tx antenna. For example, assume one Rx antenna:

Let hₗ (n; a) be the lth multipath time domain component at time instant n and ath Tx antenna.

H (n; a) be the vector of stacked up H(f, n; a) for various f and h (n; α) be the vector of stacked up hₗ (n; a) for various l.

Let F be the sampled FFT matrix with rows corresponding to indices of f and columns corresponding to indices of l. We have H (n; a)=h (n; a). Assume length of H (n; a)>length of h (n; a).

Define hₗ (n; a)=[hₗ(n−P+1; a) . . . hₗ (n; a)], where P is order of prediction and a is a P×1 vector of LPC coefficients (assumed, for simplicity, to be same across Z multipaths).

Linear channel prediction Training: learn the coefficient vector a. Happens in the first N₁ time instants. The training equation to learn a is

$$[ \begin{matrix}{h}_{l} ( n ; a ) \\ {h}_{l} ( n - 1 ; a ) \\ ⋮ \\ {h}_{l} ( n - K + 1 ; a )\end{matrix} ] a = [ \begin{matrix}{h}_{l} ( n + 1 ; a ) \\ {h}_{l} ( n ; a ) \\ ⋮ \\ {h}_{l} ( n - K + 2 ; a )\end{matrix} ]$$

Training may happen across Tx antennas. Literature says predictor coefficients are roughly same across Tx antennas and subbands.

The LCP vector a is assumed, for simplicity, to be constant across all Z multipaths (though not necessary).

Prediction [symbol] (n+1; a)=hₗ (n; a)a typically happens after the Nₗ time-domain sample instants.

Feedback to the network apparatus (BS): Quantized LPC ā^{⋅} (optional)

Quantized channel error value e̅ₗ̅(n; a) for n>N₁. Feedback of e̅ₗ̅(n; a) is assumed to take lesser bits than feedback of h̅ₗ̅(n; a)−h̅ₗ̅(n−1; a). (Need to be verified by simulations, but generally prediction error is less than error w.r.t previous sample).

Computing e̅ₗ̅(n; a):

For the first N₁ samples (n≤N₁), h̅ₗ̅(n; a) is fed back as usual.

For n>N₁, h̅ₗ̅(n; a)=ā h̅₁̅(n−1; a) and

eₗ(n;a)=hₗ(n;a)−āh̅₁̅(n−1;a), feed back e̅ₗ̅(n;a)

The network apparatus computes [symbol] (n; a)=e̅ₗ̅(n; a)⁺ā h̅ₗ̅(n−1; a).

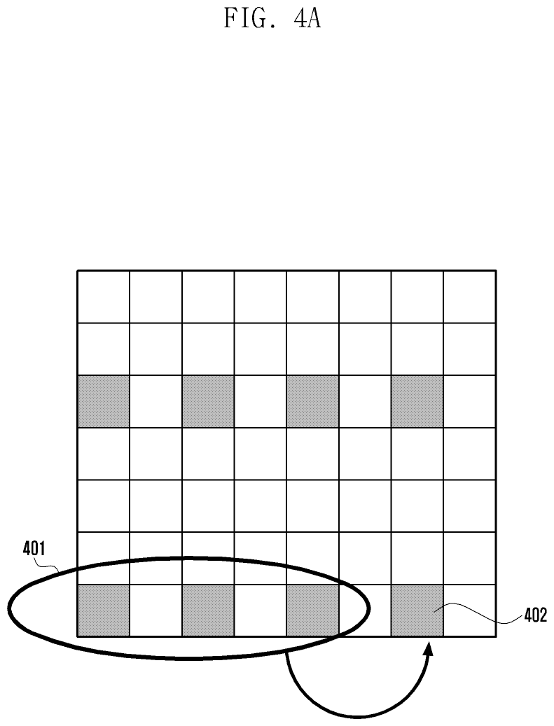

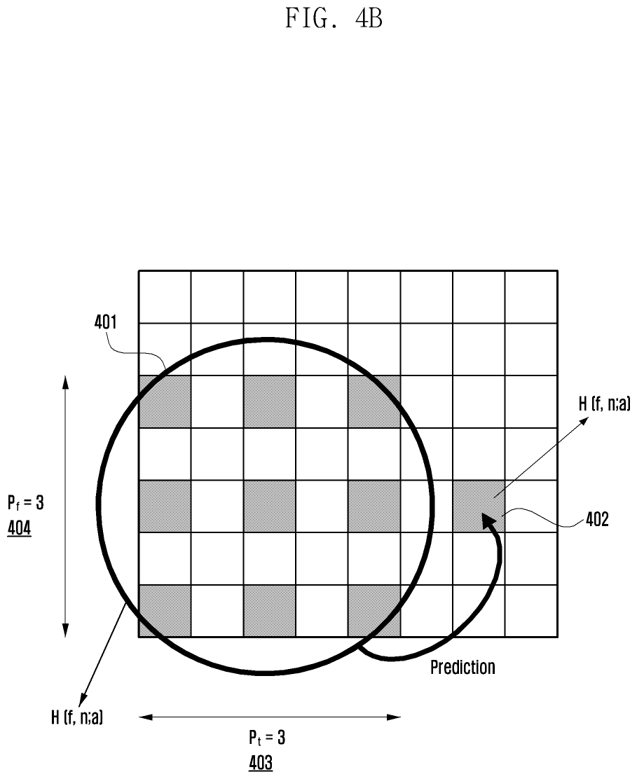

FIG. 4A illustrates a scenario of determining a channel by a time domain interpolation, according to the prior arts;

Referring to FIG. 4A a pilot (401), and predicted values (402). The network apparatus determines channel using H(n)=F h(n). The network apparatus may also use 2D channel prediction using neighbouring pilot (401) across frequency/time at this instant and before this instant to determine the channel. The network apparatus may determine the channel using the time domain interpolation, or 2D channel prediction. The prediction may also happen in frequency domain along a given subcarrier across time.

FIG. 4B illustrates a scenario of determining a 2D channel by a time domain interpolation, according to the prior arts;

Referring to FIG. 4B depicts prediction order in time domain Pt (403), prediction order in frequency domain Pf (404). The prediction order in time domain Pt (403) may depend on coherence time. The prediction order in frequency domain Pf (404) may use neighboring subbands and depends on coherence bandwidth. Harnessing frequency domain correlation, in addition to time domain, reduces prediction error and hence the feedback.

The LCP coefficients are roughly constant across subbands, antennas and small durations of time as it is mainly dependent on Doppler frequency.

LPC coefficient vector a₁ is PₜP_{f}×1 vector . . . (iii)

For example, LPC equation for 2D case is

$$[ \begin{matrix}H ( {f}_{1 ,} n ; a ) \\ H ( {f}_{2 ,} n ; a ) \\ ⋮ \\ H ( {f}_{N 3} , n ; a )\end{matrix} ] {a}_{1} = [ \begin{matrix}H ( {f}_{1 ,} n ; a ) \\ H ( {f}_{2 ,} n ; a ) \\ ⋮ \\ H ( {f}_{N 3} , n ; a )\end{matrix} ]$$

where N3>PₜP_{f}

Training may happen at more than one-time instant n and also across antennas a.

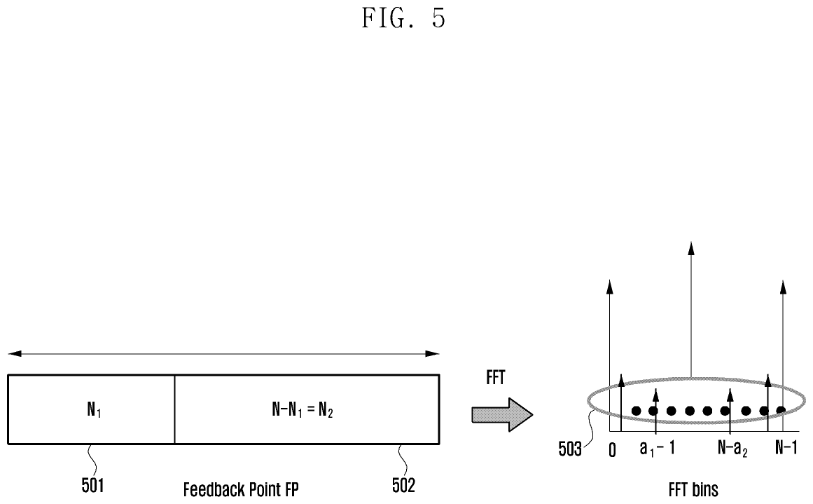

FIG. 5 illustrates a scenario of predicting a signal using the quantized low pass FFT bins, according to the prior arts;

Referring to FIG. 5 depicts N1 sample (501), and N2 prediction signal (502), and FFT bins (503).

hₗ(n; a) but could as well be H (f, n; a) along a subcarrier in time-domain.

obtaining the ‘a’ low-pass FFT bins (503) from the N₁ samples (501) and feedback to the network apparatus at feedback point. The N₁ samples (501) come from channel estimation of CSI-RS.

N−N1=N2, the prediction signal (502) using the quantized ‘a’ low pass FFT bins (503), subtract from the actual value (assuming CSI-RS is present) and feedback the error to the network apparatus (601). Alternatively, if no CSI-RS here and just the network apparatus (601) uses the reconstructed signal over this region.

a=a₁+a₂ low pass FFT bins (503), a<<N, characterizes all N samples

For n≤N₁ and assuming N₁≥a compute Doppler coefficients as

$$\frac{1}{N} [ \begin{matrix}{f}_{0}^{*} ( 0 : {N}_{1} - 1 ) & … & {f}_{{a}_{1} - 1}^{*} ( 0 : {N}_{1} - 1 ) & {f}_{N - {a}_{2}}^{*} ( 0 : {N}_{1} - 1 ) & … & {f}_{N - 1}^{*} ( 0 : {N}_{1} - 1 )\end{matrix} ] {d}_{l} = [ \begin{matrix}{h}_{l} ( 0 ) \\ ⋮ \\ {h}_{l} ( {N}_{1} - 1 )\end{matrix} ] \qquad ( iv )$$

where dₗ is a×1 vector of Doppler coefficients fed back to the network apparatus and fᵢ is the i-th column of N×N FFT matrix.

For n>N₁, reconstruct hₗ(n) as

$$\frac{1}{N} [ \begin{matrix}{f}_{0}^{*} ( {N}_{1} : end ) & … & {f}_{{a}_{1} - 1}^{*} ( {N}_{1} : end ) & {f}_{N - {a}_{2}}^{*} ( {N}_{1} : end ) & … & {f}_{N - 1}^{*} ( {N}_{1} : end )\end{matrix} ] {d}_{l} = [ \begin{matrix}( {N}_{1} ) \\ ⋮ \\ ( N - 1 )\end{matrix} ] \qquad ( v )$$

The UE (101) feeds back dₗ to BS at FP along with e̅ₗ̅(n) where eₗ(n)=hₗ(n)− [symbol] (n). BS computes hₗ(n) as [symbol] (n)+eₗ(n). Alternatively, if there is no CSI-RS during the N₂ samples, BS just uses [symbol] (n).

In 2D-FFT, the channel varies slowly in both time and frequency. The Doppler component method may also be extended to two dimensions (time and frequency) and based on 2D-FFT method.

In an embodiment, for fading it is known that the Kalman estimators generates MMSE estimates.

LCP coefficients, channel predictor error variance and error variance associated with observation. In the proposed method, observation is quantized and observation noise is quantization noise. If we feedback channel predictor error variance and quantization noise variance along with LPC coefficients, the network apparatus may estimate the channel more accurately (overcomes quantization loss). Simulations needed to ascertain benefits, though. Since Kalman does prediction and correction as against the prediction method, which does only prediction. Kalman may have low prediction orders than prediction method. N₂ may be bigger for Kalman method than channel prediction method, thereby having lesser feedback.

The Doppler-space domain precoder for the l-th transmission layer, the s-th subband, the two polarizations for T occasions of CSI-RS are given by

$${P}^{( l )} ( s ) = {P}^{( l )} [ \begin{matrix}{\sum }_{u = 0}^{{U}^{( l )} - 1} {\sum }_{v = 0}^{{F}_{u}^{( l )} - 1} {γ}_{1 , s , u , v}^{( l )} {f}_{1 , u , v}^{( l )} ⊗ {b}_{u}^{( l )} \\ {\sum }_{u = 0}^{{U}^{( l )} - 1} {\sum }_{v = 0}^{{F}_{u}^{( l )} - 1} {γ}_{2 , s , u , v}^{( l )} {f}_{2 , u , v}^{( l )} ⊗ {b}_{u}^{( l )}\end{matrix} ] \qquad ( vi )$$

which is W₁W₂(:, s, 1:T) after dropping the second dimension (similar to matlab squeeze function) in W₂ where U^{(l)} is the number of beams per polarization for the l-th layer.

$${f}_{u}^{( l )}$$

is the number of Doppler-frequency components for the l-th layer and u-th beam,

$${b}_{u}^{( l )}$$

is the u-th spatial beam associated with the l-th layer;

$${f}_{p , u , v}^{( l )}$$

is the v-th Doppler-frequency vector (DFT based) of size 1×T associated with the l-th layer, u-th spatial beam, and the p-th (p=1,2) polarization of the precoder,

$${γ}_{p , s , u , v}^{( l )}$$

is the complex combination coefficient associated with the l-th layer, u-th spatial beam, v-th Doppler-frequency, s-th sub-band, and the p-th polarization of the precoder, and

P^{(l)} is a scalar normalisation factor to ensure a certain total transmission power.

The total feedback is the sum of Doppler frequency locations and Doppler frequency coefficients across beams and layers. The former is given by

$$2 {\sum }_{u , l} {F}_{u}^{( l )}$$

and the latter is given by

$${γ}_{p , s , u , v}^{( l )}$$

for all p, u, v, l.

The PMI report containing the Doppler-frequency components can be used at the gNB within the stationary time of the channel to facilitate predictive multi-user scheduling and/or multi-user precoder matrix prediction. For example, for the precoder matrix prediction, the length-T Doppler-frequency DFT-vectors

$${f}_{p , u , v}^{( l )}$$

are reconstructed at the gNB based on the PMI report and extended to length-QT vectors

$${t}_{p , u , v ,}^{( l )} ,$$

the extension defined by

$${t}_{p , u , v}^{( l )} = [ 1 , … , {e}^{j 2 π kq} , … , {e}^{j 2 π k ( Q - 1 )} ] ⊗ {f}_{p , u , {v}^{′}}^{( l )} where$$

$${f}_{p , u , v}^{( l )} = [ 1 , {e}^{j \frac{2 π k}{T}} , … , {e}^{j \frac{2 π k ( T - 1 )}{T}} ]$$

is the selected DFT vector from the DFT Doppler codebook, where k is a multiple of 1/O with O being oversampling factor.

The predicted Doppler-space precoder matrix for the l-th layer, s-th subband, and q-th (q=1, . . . , [symbol] T) future time instant is then given by

$${P}^{( l )} ( s , q ) = {P}^{( l )} [ \begin{matrix}{\sum }_{u = 0}^{{U}^{( l )} - 1} {\sum }_{v = 0}^{{F}_{u}^{( l )} - 1} {γ}_{1 , s , u , v}^{( l )} {t}_{1 , u , v}^{( l )} ( q ) ⊗ {b}_{u}^{( l )} \\ {\sum }_{u = 0}^{{U}^{( l )} - 1} {\sum }_{v = 0}^{{F}_{u}^{( l )} - 1} {γ}_{2 , s , u , v}^{( l )} {t}_{2 , u , v}^{( l )} ( q ) ⊗ {b}_{u}^{( l )}\end{matrix} ] , \qquad ( vii )$$

$$where {t}_{p , u , v}^{( l )} ( q )$$

is the q-th entry of vector

$${t}_{p , u , v}^{( l )} .$$

The Delay-Doppler-space domain precoder for the l-th transmission layer, the two polarizations for T occasions of CSI-RS and all subbands is given by

$${P}^{( l )} = {P}^{( l )} [ \begin{matrix}{\sum }_{u = 0}^{{U}^{( l )} - 1} {\sum }_{d = 0}^{{D}_{u}^{( l )} - 1} {\sum }_{v = 0}^{{F}_{d , u}^{( l )} - 1} {γ}_{1 , d , u , v}^{( l )} {d}_{1 , u , d}^{( l )} ⊗ {f}_{1 , u , d , v}^{( l )} ⊗ {b}_{u}^{( l )} \\ {\sum }_{u = 0}^{{U}^{( l )} - 1} {\sum }_{d = 0}^{{D}_{u}^{( l )} - 1} {\sum }_{v = 0}^{{F}_{d , u}^{( l )} - 1} {γ}_{2 , d , u , v}^{( l )} {d}_{2 , u , d}^{( l )} ⊗ {f}_{2 , u , d , v}^{( l )} ⊗ {b}_{u}^{( l )}\end{matrix} ] \qquad ( viii )$$

(Here S is number of subbands).

U^{(l)} is the number of beams per polarization for the l-th layer,

$${F}_{u}^{( l )}$$

is the number of Doppler-frequency components for the l-th layer and u-th beam,

$${b}_{u}^{( l )}$$

is the u-th spatial beam associated with the l-th layer;

$${f}_{p , u , d , v}^{( l )}$$

is the y-th Doppler-frequency vector (DFT based) of size 1×T associated with the l-th layer, u-th spatial beam, dth delay, and the p-th (p=1, 2) polarization of the precoder,

$${d}_{p , u , d}^{( l )}$$

is S×1 d-th delay vector (DFT based) associated with p-th polarization and u-th beam.

$${γ}_{p , d , u , v}^{( l )}$$

is the Doppler frequency coefficient associated with the l-th layer, u-th spatial beam, v-th Doppler-frequency, d-th delay and the p-th polarization of the precoder, and P^{(l)} is a scalar normalisation factor to ensure a certain total transmission power.

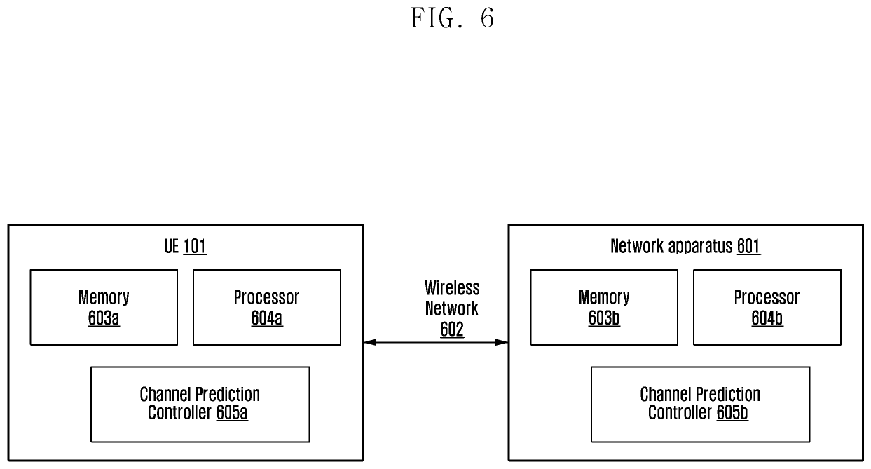

FIG. 6 illustrates a system of channel predication in a wireless network, according to the embodiments as disclosed herein.

FIG. 6 includes, the UE (101), a network apparatus (601), and a wireless network (602). The UE (101) includes a memory (603a), a processor (604a), and a channel prediction controller (605a). The network apparatus includes a memory (603b), a processor (604b), and a channel prediction controller (605b).

The memory (603a) is configured to store instructions to be executed by the processor (604a). [symbol] rocessors.

The one or the plurality of processors is a general-purpose processor, such as a central processing unit (CPU), an application processor (AP), or the like, a graphics processing unit such as a graphics processing unit (GPU), a Visual Processing Unit (VPU), and/or an AI dedicated processor such as a neural processing unit (NPU). The processor (604a) includes multiple cores and is configured to execute the instructions stored in the memory (603a).

In an embodiment, the UE (101) includes the channel prediction controller (605a) communicatively coupled to the memory (603a) and the processor (604a) may be configured to measure a channel in the observation window (OW) (102); determine a spectral estimation of the channel in the OW (102), determine channel parameters based on the spectral estimation of the channel in the OW (102), the plurality of channel parameters includes a number of transmit antennas at the network apparatus (601), a number of receive antennas at the network apparatus (601), subbands used by the UE (101), a number of angles and number of delays in the channel, and doppler values and combinations of aforementioned parameters; and send the channel parameters to the network apparatus (601) in the wireless network (602) for prediction or reconstruction of a channel in the predication window (PW) (103).

In an embodiment, the network apparatus (601) includes a channel prediction controller (605b) communicatively coupled to the memory (603b) and the processor (604b) may be configured to receive the channel parameters from the UE (101); and predict or reconstruct the channel in the predication window (103) based on the channel parameters received from the UE (101).

In an embodiment, a channel state information (CSI) prediction based on UE capability, the complexity associated with these algorithms are very high on the UE (101) side. The complexity is dependent on number of transmit antennas at the network apparatus (601), NRx and number of subbands, number of multipaths (delays) in the channel, frequency-selectivity (coherence bandwidth) the Doppler value (stationary time, coherence time, observation and prediction window lengths are all dependent on Doppler). The UE (101) may be configured to convey the UE capability (whether it will do prediction or not) and also condition it on the parameters to the network apparatus (601). The parameters may include, but not limited to, number of transmit antennas at the network apparatus (601), NRx and number of subbands and number of delays in the channel, the Doppler value, and the like.

The UE (101) may also convey to the network apparatus (601) about determining the UE capability based on the AR prediction, linear LMMSE or spectral based prediction. This type of prediction may directly impact the lengths of the observation window (102) and the prediction window (103) that are determined by the network apparatus (601).

For example, the UE (101) may do prediction if the network apparatus (601) includes eight antennas and not 64 antennas, performs prediction on small cells with lesser number of multipath and not macro cells with larger number of paths, could do prediction for smaller Doppler (bigger observation, prediction window size) but not for higher Doppler and the like, lesser delay spreads (lesser frequency selectivity and bigger subband size) but not for bigger delay spreads etc.

Therefore, the network apparatus (601) may decide to take UE's (101) help in prediction or performs its own prediction based on this capability information from the UE (101) that is also tied to these channel/antenna parameters, and the like. Alternatively, it may be a simple YES or NO from the UE (101) on its capability to do prediction without dependency on any other parameters.

In an embodiment, the method for CSI prediction based on UE capability includes determining, by the UE (101), the UE capability information and the channel parameters; The UE capability information includes, whether the UE predicts or not, whether it is doing AR, linear LMMSE or spectral based prediction. This type of prediction may directly impact observation/prediction window lengths that is determined by the network apparatus (601); sending, by the UE (101), the UE capability information and the channel parameters to the network apparatus (601); receiving, by the network apparatus (601), the UE capability information and the channel parameters; and determining, by the network apparatus (601), the length of the OW (102) and the length of the PW (103) is based on the UE capability information and the channel parameters. Determining, by the network apparatus (601), whether to take the UE (101) assistance from the UE (101) in predicting the OW length and the PW length or to perform the prediction based on the UE capability information received from the UE (101). Determining the UE capability information and the channel parameters based on the AR prediction; the linear prediction, the linear minimum mean square error (LMMSE); and the spectral based prediction performed by the UE (101).

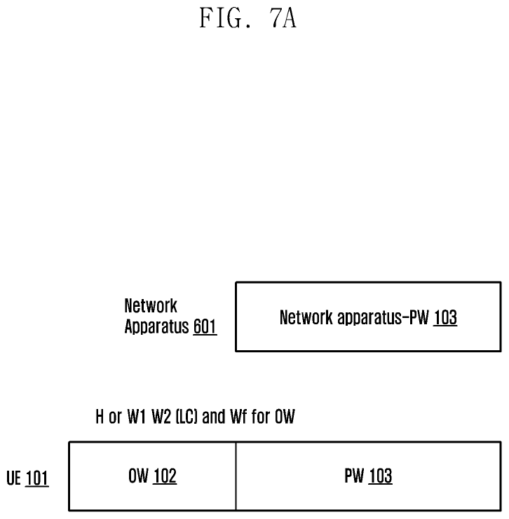

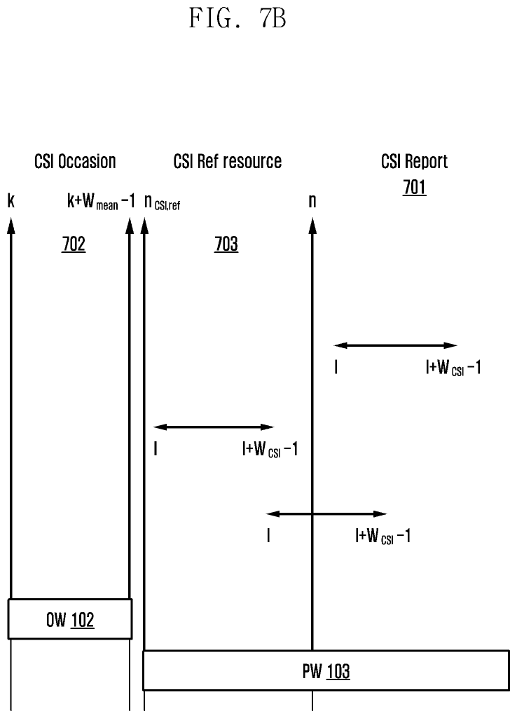

FIG. 7A illustrates a scenario of channel prediction at the UE side, according to the embodiments as disclosed herein.

Referring to the FIG. 7A considering the proposed method, the UE (101) observe channel in the observation window (102), the UE (101) may “compress” and “send” Precoding matrix information like W1, W2 (linear coefficients) and Wf, (or H) corresponding to the OW (102) to the network apparatus (601). The network apparatus (601) may predict H or W1, W2 (linear coefficient) and Wf independently for the prediction window (103). W2 (LC) precoding matrix needs to be designed to avoid loses of phase information.

The UE (101) may be configured to measure channel in the observation window (102) and predict the channel (W1, W2 and Wf) for the prediction window (103). Prediction may be different for each pre-coding matrix. (i.e W1, W2 and Wf). Each pre-coding matrix may include different prediction window. For example, each precoding matrix may independently adapt the prediction window on dynamically or semi static basis. The UE (101) may also indicate the UE capability to the network apparatus (601) on the length of the prediction window (103) and spatial elements to be used for the prediction.

In an embodiment, the method for channel prediction at the UE side includes predicting, by the UE (101), the channel in the PW (103) based on the measurements of channel of the OW (102); determining, by the UE (101), a precoding matrix index for the predicted channel in the PW (103); The precoding matrix index may include, but not limited to, W1,W2 (linear coefficients) and Wf, (or H), and other approximations of channel matrix. The method includes compressing, by the UE (101), the precoding matrix index in the PW (103); sending, by the UE (101), the precoding matrix index in the PW (103) to the network apparatus (601) at end of the OW (102); receiving, by the network apparatus (601), the precoding matrix index in the PW (103) from the UE (101); and determining, by the network apparatus (601), precoders in the PW (103) using the precoding matrix index; The precoders may be an approximation of a channel; predicting, by the UE (101), the precoding matrix index directly in the PW (103) based on the precoding matrix index in the OW (102).

FIG. 7B illustrates a scenario of channel prediction at the network apparatus, according to the embodiments as disclosed herein.

Referring to the FIG. 7B considering the proposed method, the UE (101) may observe channel in the observation window (102) and should “compress” and “send” Precoding matrix information like (W1, W2 (linear coefficients) and Wf, (or H) corresponding to the OW (102) to the network apparatus (601). The network apparatus (601) may predict H or W1, W2 (LC) and Wf for prediction window (103). W2 (LC) precoding matrix needs to be designed to avoid loses of phase information.

The UE (101) may be configured to measure channel in observation window (102) and predict channel (W1, W2 and Wf) for prediction window (103). Prediction may be different for each pre-coding matrix (i.e W1, W2 and Wf). Each pre-coding matrix may include different prediction window. For example, each pre-coding matrix may independently adapt prediction window on dynamically or semi static basis. The UE (101) may indicate the UE capability to the network apparatus (601) on the length of prediction window (103) and spatial elements to be used for prediction.

On the CSI reporting and measurement for the Type-II codebook refinement for high/medium velocities, at least for discussion purposes, define the following: Assume a CSI report (701) in slot n, and let the length of the DD/TD basis vector be N4. Note that basis vector has no span/window in time-domain, only length. CSI-RS measurement window (702) of [k,k+Wmeas−1], which is considered as the observation window (102), representing the window in which CSI-RS occasion(s) are measured for calculating the CSI report (701), k is a slot index and Wmeas is the measurement window length (in slots) In the legacy Rel-16/17 CSI, the CSI-RS occasion(s) are configured in CSI-ReportConfig.

CSI reporting window of [l,l+WCSI−1], associated to the CSI report in slot n. l is a slot index and WCSI is the reporting window length (in slots). Reporting window i.e. l,l+WCSI−1 could lie within reference resource occasion i.e. (n−n_{CSI,ref}), across reference resource occasion and CSI reporting interval, and/or within CSI reporting interval. CSI report window (701) i.e. l,l+WCSI−1 may fall within the prediction window (103) after the observation window (102) till reports.

CSI reference resource(s) (703) in time-domain. The location of the CSI reference resource (703) is denoted as nref (slot index).

On the CSI reporting and measurement for the Rel-18 Type-II codebook refinement for high/medium velocities, when UE-side prediction is assumed, support the UE (101) or network apparatus (601) “predicting” channel/CSI after slot l where the location of slot l is configured (from multiple candidate values) by the network apparatus (601) via higher-layer signalling

Candidates of slot l location include the legacy CSI reference resource location (n−n_{CSI,ref}) and slot (n+β) where δ≥0

Note: Per legacy behavior, the legacy CSI reference resource (703), i.e., (n−n_{CSI,ref}), is reused for locating the last CSI-RS occasion used for the CSI report (701).

For the UE (101) that supports UE-side prediction, the support of l=(n−n_{CSI,ref}) is UE optional.

For the Rel-18 Type-II codebook refinement for high/medium velocities,

For PMI, DD unit duration of d (in slots) is the duration associated with each of the N₄ W₂ matrices (combining coefficients before DD compression at the UE, or after DD de-compression at the network apparatus (601).

TBD (by RAN1 #111): The time instance and/or PMI(s) in which a CQI is associated with, given the CSI reporting window W_{CSI} (in slots), and the number of CQI(s) X included in the CSI report (701).

For the Type-II codebook refinement for high/medium velocities, the parameter W_{CSI} (in slots) is determined as follows: W_{CSI}=dN₄.

For the Type-II codebook refinement for high/medium velocities, the parameter N₄ (length of DFT vector, unit-less) is configured by the network apparatus (601) via higher-layer (RRC) signaling at least from the following set of candidate values: {1, 2, 4}

FFS: If additional candidate value(s) of N4 are supported, e.g. 3, 5, 6, 8, 10, 16, 32, as well as the supported Parameter Combination(s).

For the Type-II codebook refinement for high/medium velocities, regarding the parameter N4 (length of DFT vector, unit-less), support 8 as an additional candidate value.

FFS (by RAN1 #112): Whether any of the following additional candidate values are supported: 3, 5, 16, 32

The candidate values supported by the UE (101) are reported via the UE capability.

In an embodiment, DD unit duration of d (in slots) is the duration associated with each of the N4 W2 matrices and For the Type-II codebook refinement for high/medium velocities, the parameter WCSI (in slots) as reporting window is determined as follows: WCSI=dN4.

This operation is equivalent to the prediction window (103) as per the specifications and d (in slots) N4 is equivalent to the length of prediction window (103). Where N4 is a length of DFT vector in time domain and understood as unit less entity. The UE (101) may also indicate the UE capability to the network apparatus (601) on the length of prediction window (103) and spatial elements to be used for prediction. As per agreement for configured window of d the candidate values of N4 supported by the UE (101) are reported via UE capability, which is equivalent to the prediction window (103).

In an embodiment, the method for the channel prediction at the network apparatus (601) includes measuring, by the UE (101), the channel in the OW (102); determining, by the UE (101), the precoding matrix index of the channel corresponding to the OW (102); compressing, by the UE (101), the precoding matrix index of the channel corresponding to the OW (102); sending, by the UE (101), the compressed precoding matrix index corresponding to the OW (102) to the network apparatus (601) for the PW (103) to apply directly without performing prediction at the network apparatus (601). The UE (101) may predict the channel for the PW (103), and send the predicted channel to the network apparatus (601) to use in the PW (103).

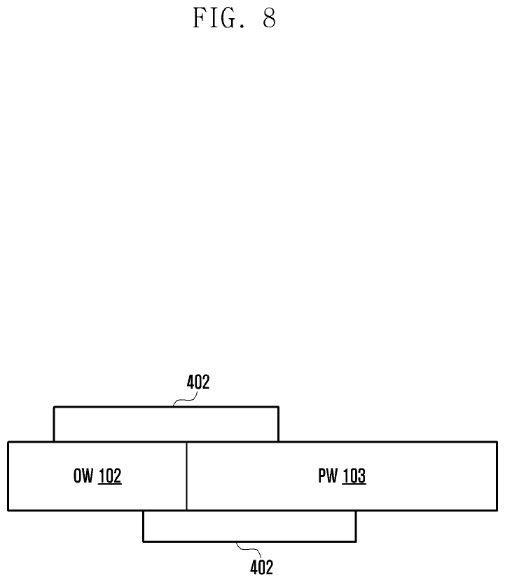

Referring to the FIG. 8 considering the proposed method, the UE (101) may observe channel (H) in the observation window (102), the UE (101) may predict channel (H) in part of prediction window (103) in steps means the entire OW (102) is used to predict a first sample (801) in the PW (103), the entire OW (102) is used to predict a second sample (802) in the PW (103) and so on. Linear prediction, AR prediction, wiener prediction may be leveraged for prediction purpose.

In an embodiment, the method for the channel prediction in steps includes measuring, by the UE (101), the channel in the OW (102); and determining, by the UE (101), a channel in multiple parts of the PW (103), each part of the plurality of parts of the PW is determined based on entire OW. The multiple parts may include, the first sample (801), the second sample (802), and the like.

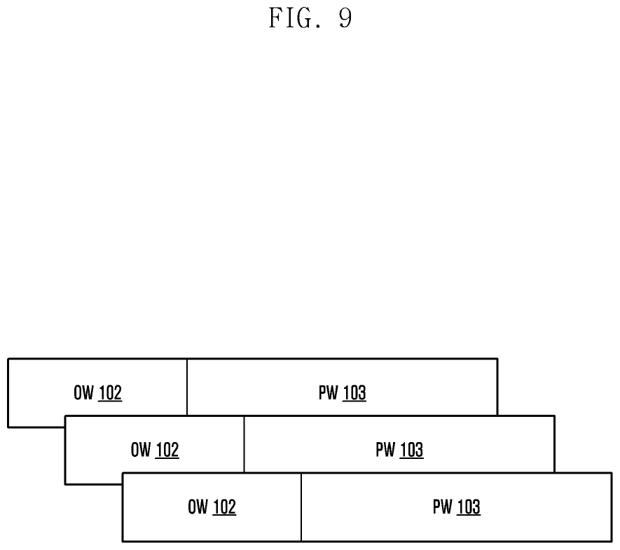

FIG. 9 illustrates a scenario of configuring the sliding window length based the CSI received from the UE, according to the embodiments as disclosed herein;

Referring to the FIG. 9 considering the proposed method, the UE (101) may observe channel (H) in the observation window (102), the UE may predict channel (H) in part of prediction window (103). Observation window (102) may keep on sliding. A predictions sample may become input for the next prediction window. In this method, error may keep propagate. Linear prediction, AR prediction, wiener prediction may be leveraged for prediction purpose.

Sliding of the observation window (102) and the prediction window (103) may be made dynamic or semi static for each channel H and precoding matrix index (W1, W2 Wf). Sliding may be based on the error propagation of each precoding matrix index. Sliding window length may feedback to the network apparatus (601) for the network apparatus (601) to adapt the prediction window (103); either based on CSI received from the UE (101) or prediction at the network apparatus (601) based on CSI received at based on the network apparatus (601) specific prediction method.

In an embodiment, determining, by the UE (101), a sliding window of the OW based on an error propagation of the precoding matrix index; feeding back, by the UE (101), a sliding window length to the network apparatus (601) to adapt the PW (103) at the network apparatus (601); and configuring, by the network apparatus (601), the sliding window length based on a CSI received from the UE (101), and a predicted CSI at the network apparatus (601) using the CSI received from the UE (101).

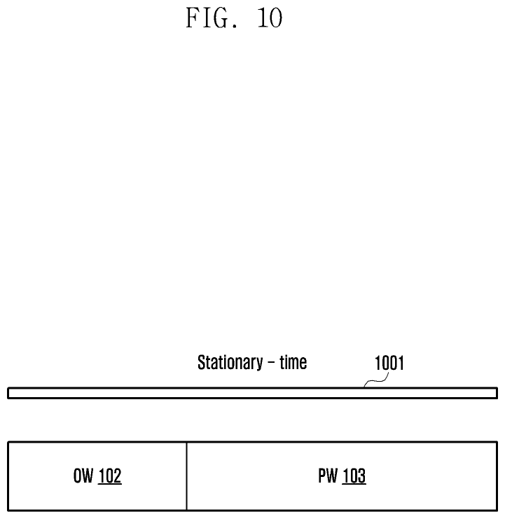

FIG. 10 illustrates a scenario of channel prediction for large stationary time, according to the embodiments as disclosed herein.

Referring to the FIG. 10 considering the proposed method, the UE (101) may observe channel (H) in the observation window (102), the UE (101) may predict channel (H) in part of prediction window (103). Stationary time=100×Coherence time. The UE (101) may predict the channel in large stationary time (1001). Prediction methods are based on spectral estimation of Doppler components in the OW (102).

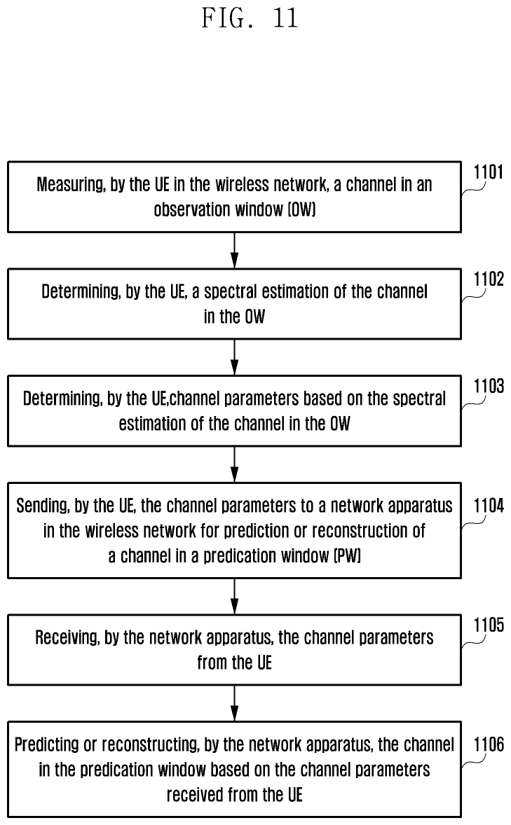

FIG. 11 is a flow chart illustrating a method for channel prediction in the wireless network, according to the embodiment as disclosed herein;

At step 1101, the method includes measuring, by the UE in the wireless network, the channel in the observation window (OW);

At step 1102, the method includes determining, by the UE, the spectral estimation of the channel in the OW;

At step 1103, the method includes determining, by the UE, the channel parameters based on the spectral estimation of the channel in the OW;

At step 1104, sending, by the UE, the channel parameters to the network apparatus in the wireless network for prediction or reconstruction of the channel in a predication window (PW).

At step 1105, receiving, by the network apparatus, the channel parameters from the UE; and

At step 1106, predicting or reconstructing, by the network apparatus, the channel in the predication window based on the channel parameters received from the UE.

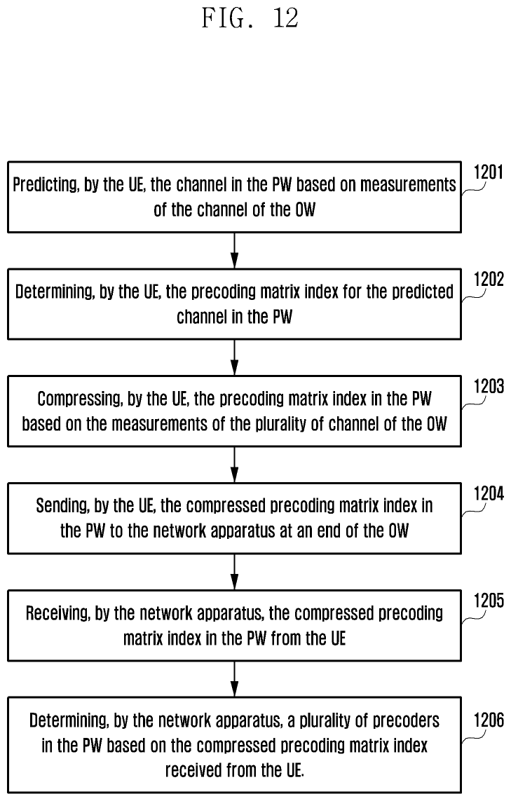

FIG. 12 is a flow chart illustrating a method for the channel prediction at the UE, according to the embodiment as disclosed herein;

At step 1201, predicting, by the UE, the channel in the PW based on measurements of the channel of the OW;

At step 1202, determining, by the UE, the precoding matrix index for the predicted channel in the PW;

At step 1203, compressing, by the UE, the precoding matrix index in the PW based on the measurements of the plurality of channel of the OW;

At step 1204, sending, by the UE, the compressed precoding matrix index in the PW to the network apparatus at an end of the OW;

At step 1205, receiving, by the network apparatus, the compressed precoding matrix index in the PW from the UE; and

At step 1206, determining, by the network apparatus, a plurality of precoders in the PW based on the compressed precoding matrix index received from the UE.

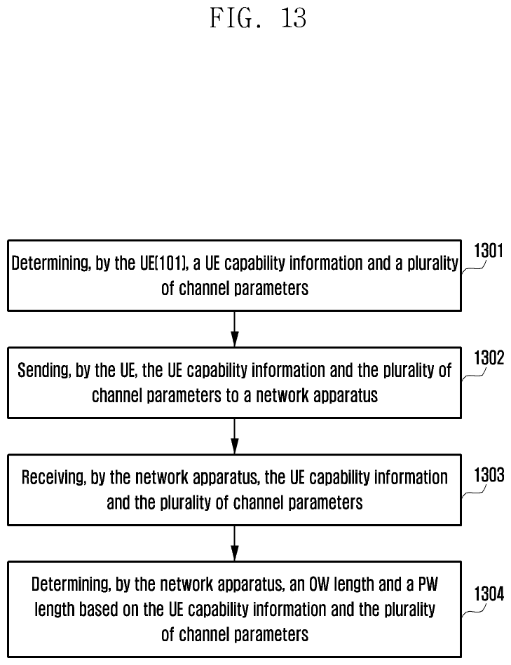

FIG. 13 is a flow chart illustrating a method for the channel prediction based on UE capability, according to the embodiment as disclosed herein;

At step 1301, the method includes determining, by the UE, the UE capability information and the channel parameters;

At step 1302, the method includes sending, by the UE, the UE capability information and the channel parameters to the network apparatus;

At step 1303, the method includes receiving, by the network apparatus, the UE capability information and the plurality of channel parameters; and

At step 1304, the method includes determining, by the network apparatus, the OW length and the PW length based on the UE capability information and the channel parameters.

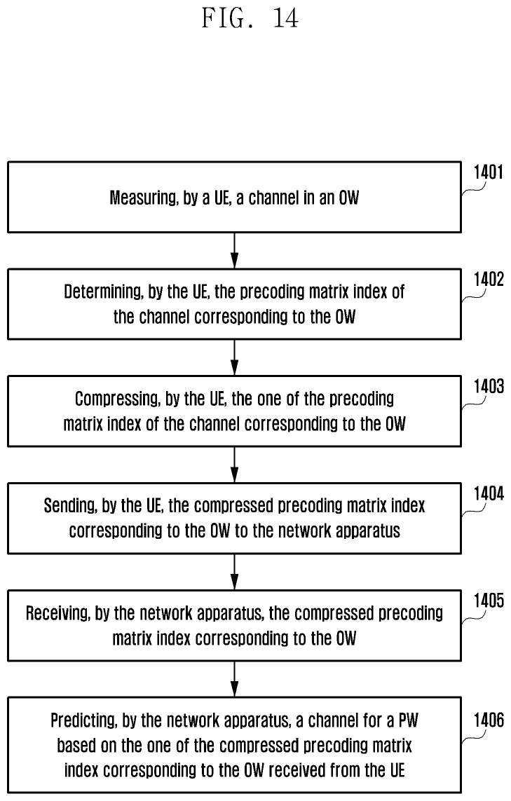

FIG. 14 is a flow chart illustrating a method for the channel prediction in the OW, according to the embodiment as disclosed herein;

At step 1401, measuring, by the UE, the channel in the OW;

At step 1402, determining, by the UE, the precoding matrix index of the channel corresponding to the OW;

At step 1403, compressing, by the UE, the precoding matrix index of the channel corresponding to the OW;

At step 1404, sending, by the UE, the compressed precoding matrix index corresponding to the OW to the network apparatus;

At step 1405, receiving, by the network apparatus, the compressed precoding matrix index corresponding to the OW; and

At step 1406, predicting, by the network apparatus, the channel for the PW based on the compressed precoding matrix index corresponding to the OW received from the UE.

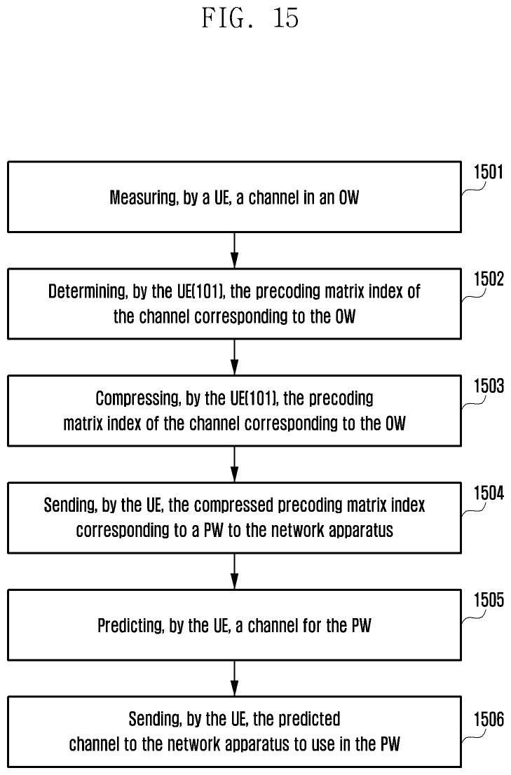

FIG. 15 is a flow chart illustrating a method for the channel prediction in the PW, according to the embodiment as disclosed herein.

At step 1501, measuring, by the UE, the channel in the OW;

At step 1502, determining, by the UE, the precoding matrix index of the channel corresponding to the PW;

At step 1503, compressing, by the UE, the precoding matrix index of the channel corresponding to the PW;

At step 1504, sending, by the UE, the compressed precoding matrix index corresponding to the PW to the network apparatus, the network apparatus applies the compressed precoding matrix in the PW directly without performing prediction at the network apparatus;

At step 1505, predicting, by the UE, the channel for the PW; and

At step 1506, sending, by the UE, the predicted channel to the network apparatus to use in the PW.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method performed by a User Equipment (UE) in a wireless network, the method comprising:
measuring a channel in an observation window (OW);
determining a spectral estimation of the channel in the OW;
determining a plurality of channel parameters based on the spectral estimation of the channel in the OW; and
transmitting, to a network apparatus, a UE capability information and the plurality of channel parameters,
wherein the UE capability information includes candidate value of a N4 parameter indicating a length of discrete fourier transform (DFT) vector.

2. The method of claim 1, wherein the method further comprising:
determining a precoding matrix index of the channel corresponding to the OW;
compressing the precoding matrix index; and
transmitting, to the network apparatus, the compressed precoding matrix index.

3. The method of claim 1,
wherein a length of a reporting window is determined based on duration associated with the N4 parameter.

4. The method as claimed in claim 1,
wherein a reporting window is located within reference resource occasion or channel state information (CSI) reporting interval.

5. A method performed by a network apparatus in a wireless network, the method comprising:
receiving, from a User Equipment (UE), a UE capability information and the plurality of channel parameters; and
determining a length of an observation window (OW) and a length of a prediction window (PW) based on the UE capability information and the plurality of channel parameters,
wherein the UE capability information includes candidate value of a N4 parameter indicating a length of discrete fourier transform (DFT) vector.

6. The method of claim 5, further comprising:
receiving, from the UE, compressed precoding matrix index in the PW; and
determining a plurality of precoders in the PW based on the compressed precoding matrix index.

7. The method of claim 5, further comprising:
determining a length of a reporting window based on duration associated with the N4 parameter.

8. The method of claim 5,
wherein a reporting window is located within reference resource occasion or channel state information (CSI) reporting interval.

9. A User Equipment (UE) in a wireless network, the UE comprising:
a memory; and
a controller coupled to the memory and configured to:
measure a channel in an observation window (OW),
determine a spectral estimation of the channel in the OW,
determine a plurality of channel parameters based on the spectral estimation of the channel in the OW, and
transmit, to a network apparatus, a UE capability information and the plurality of channel parameters,
wherein the UE capability information includes candidate value of a N4 parameter indicating a length of discrete fourier transform (DFT) vector.

10. The UE of claim 9, wherein the controller is further configured to:
determine a precoding matrix index of the channel corresponding to the OW,
compress the precoding matrix index, and
transmit, to the network apparatus, the compressed precoding matrix index.

11. The UE of claim 9,
wherein a length of a reporting window is determined based on duration associated with the N4 parameter.

12. The UE of claim 9,
wherein a reporting window is located within reference resource occasion or channel state information (CSI) reporting interval.

13. A network apparatus in a wireless network, the network apparatus comprising:
a memory; and
a controller coupled to the memory and configured to:
receive, from a User Equipment (UE), a UE capability information and the plurality of channel parameters, and
determine a length of an observation window (OW) and a length of a prediction window (PW) based on the UE capability information and the plurality of channel parameters,
wherein the UE capability information includes candidate value of a N4 parameter indicating a length of discrete fourier transform (DFT) vector.

14. The network apparatus of claim 13, wherein the controller is further configured to:
receive, from the UE, compressed precoding matrix index in the PW, and
determine a plurality of precoders in the PW based on the compressed precoding matrix index.

15. The network apparatus of claim 13, wherein the controller is further configured to:
determine a length of a reporting window based on duration associated with the N4 parameter.
